(19) United States
(12) Patent Application Publication
(10) Pub. No.: US 2026/0001130 A1
(43) Pub. Date: Jan. 1, 2026

(54) Process for debinding a green part

(71) Applicants: ASSOCIATION POUR LA RECHERCHE ET LE DEVELOPPEMENT DES METHODES ET PROCESSUS INDUSTRIELS "ARMINES", PARIS (FR); J.P.B SYSTEME, MONTEREAU-SUR-LE-JARD (FR)

(72) Inventors: Agnès SCHNELL, PARIS (FR); Christophe COLIN, EVRY-COURCOURONNES (FR); Denis MESSAGER, MELUN (FR)

(21) Appl. No.: 19/251,913

(22) Filed: Jun. 27, 2025

(30) Foreign Application Priority Data
Jun. 28, 2024 (FR) 2407030

(51) Int. Cl. B22F 10/10; B22F 10/20; B33Y 10/00; B33Y 40/20

(52) U.S. Cl. CPC B22F 10/10; B22F 10/20; B33Y 10/00; B33Y 40/20

(57) ABSTRACT

A process for debinding a green part in which powder particles are held together by a polymer compound, the process comprising a heat treatment of the green part under a non-oxidizing atmosphere, and a thermochemical treatment of the green part under an oxidizing atmosphere for a duration less than or equal to a predetermined duration, the heat treatment and the thermochemical treatment being carried out in a same enclosure and at temperatures less than the sintering temperature (Tf) of the powder particles.

### CROSS REFERENCE TO RELATED APPLICATIONS

This application claims the benefit of FR Application No. 2407030 filed on Jun. 28, 2024 which is incorporated by reference as if fully set forth.

### TECHNICAL FIELD

The present disclosure relates to the field of additive manufacturing, and more particularly to an indirect additive manufacturing process using binder jetting on a powder bed. The present disclosure relates, in particular, to a process for debinding a green part. Such a debinding process may be used, in particular but not exclusively, for additive manufacturing of aeronautical or aerospace parts.

### BACKGROUND

Additive manufacturing refers to all the techniques used to manufacture a part not by removing material, but by successively adding material until the desired shape of the part is created. These techniques offer a number of advantages, including the ability to manufacture parts that could not be made using other processes.

Various additive manufacturing processes exist, such as Laser Powder Bed Fusion (LPBF). Recently, indirect additive manufacturing by binder jetting on powder beds has been developed (possibly on metal or ceramic powder, in which case it is known as MBJ or CBJ (for Metal Binder Jetting or Ceramic Binder Jetting respectively), which offers other industrial advantages, such as the possibility of printing a large number of parts or producing parts without cracks in non-weldable materials which, in the case of LPBF, would be subject to hot or cold cracking.

In indirect additive manufacturing by binder jetting on a powder bed, a powder bed is formed on a support, then a binder is jetted onto a surface of this powder bed corresponding to a section of the part to be manufactured. This binder is at least partially dried, for example under the effect of heating the surface of the powder bed by an infrared lamp, then a new powder bed is deposited on the previous powder bed, and so on until the entire shape of the part to be manufactured is reconstituted. The binder is then cross-linked to form a solid polymer to give the part, which is then known as a cross-linked part or “green part”, sufficient mechanical strength to withstand depowdering, an operation designed to remove excess powder from the part that is not binded by polymer. After depowdering, the green part is debinded (the polymer is removed) and then sintered, to produce the final part.

However, comparative tests have shown that the material health of parts obtained by indirect additive manufacturing by binder jetting onto a powder bed is not as good as the material health of similar parts obtained by simple sintering using the same powder, characterized by a certain chemical composition and a certain particle size distribution. The invention aims to at least partially overcome these drawbacks.

### SUMMARY

With this in mind, the inventors observed that the only difference between conventional sintering and an indirect additive manufacturing process was that the powder particles were not in contact with the binder, and that the sintered parts resulting from the indirect additive manufacturing process could, depending on the debinding conditions, have either significant porosity linked to the adsorption of oxygen at the surface of the particles during debinding, which, during the sintering cycle, generates PPBs (Prior Particle Boundaries, surfaces of the original particles) of oxides on the surface of the particles, or, when debinding is carried out in a non-oxidizing atmosphere, large carbides which form during sintering and which have a significant impact on the hardness of the sintered part.

There is therefore a need for a new debinding process.

For this purpose, the present disclosure relates to a process for debinding a green part in which powder particles are held together by a polymer compound, the process comprising a heat treatment of the green part under a non-oxidizing atmosphere, and a thermochemical treatment of the green part under an oxidizing atmosphere for a duration less than or equal to a predetermined duration, the heat treatment and the thermochemical treatment being carried out in a same enclosure and at temperatures less than the sintering temperature of the powder particles.

The powder particles may be metal or metal alloy particles, for example particles of a nickel-based superalloy such as Inconel 718 (registered trademark) or of a stainless steel. According to other embodiments, the powder particles may be non-oxide intermetallic or ceramic particles, such as nitrides, carbides, etc. The polymer compound is the compound resulting from the cross-linking of the binder after drying; this compound may comprise or consist, for the most part or entirely, of one or more polymers.

The heat treatment and the thermochemical treatment are carried out at temperatures below the sintering temperature of the powder particles, i.e. at temperatures below the temperature at which the powder particles, all other conditions being equal, are likely to sinter with one another. The debinding process therefore concerns debinding in the strict sense, excluding sintering.

The heat treatment comprises at least one temperature variation with respect to the initial temperature of the green part (for example the ambient temperature), for example at least one temperature increase and/or at least one temperature decrease, and/or maintaining the green part at a temperature different from the ambient temperature. This temperature program is carried out in a non-oxidizing atmosphere, i.e. a gas or a mixture of gases nominally comprising no oxidizing compound such as molecular oxygen, independently of the compounds that may be released into this atmosphere as a result of the degradation of the polymer compound chains. In this way, heat treatment in a non-oxidizing atmosphere enables the polymer compound chains to be degraded without the atmosphere providing oxygen to be adsorbed on the surface of the particles. However, heat treatment alone is generally not sufficient to degrade the polymer compound in its entirety: carbon-containing residues remain which tend to precipitate with the carbide-forming elements of the material during sintering.

The thermochemical treatment comprises at least one temperature variation with respect to the initial temperature of the green part (for example the ambient temperature), for example at least one temperature increase and/or at least one temperature decrease, and/or maintaining the green part at a temperature different from the ambient temperature (for example at most the end temperature of the heat treatment). The thermochemical treatment is carried out under conditions that allow a chemical reaction of the polymer compound to be coupled to the temperature program, in particular combustion of the carbon or carbon chains under an oxidizing atmosphere, in order to continue the removal of the polymer compound. This avoids the presence of carbon-containing residues in the sintered part, which would otherwise adversely affect the mechanical properties of the part after sintering. An oxidizing atmosphere designates a gas or a mixture of gases nominally comprising at least one oxidizing compound such as molecular oxygen, independently of the compounds that may be released into this atmosphere as a result of the degradation of the polymer compound chains.

The temperature program followed during the heat treatment may be different from the temperature program followed during the thermochemical treatment.

Due to the fact that the thermochemical treatment is carried out for a duration less than or equal to a predetermined duration, the thermochemical treatment is sufficiently short to enable the polymer compound to be treated without generating excessive oxidation of the powder particles, which would also limit densification during sintering. The predetermined duration may be, for example, 1 hour, preferably 30 minutes, more preferably 5 minutes or yet more preferably 3 minutes.

Moreover, the heat treatment and the thermochemical treatment are carried out in the same enclosure. The enclosure may be an oven or similar, or any device enabling a temperature program to be applied to the part while controlling the atmosphere and its pressure. Through these provisions, the green part does not leave the enclosure between the heat treatment and the thermochemical treatment. This prevents the part from regaining moisture and avoids handling the partially debinded part, which is very fragile at this stage, and optionally enables temperature continuity between the heat treatment and the thermochemical treatment (typically, to avoid the part being cooled), which increases control of the process and accelerates the debinding process.

Together, these provisions ensure effective removal of the polymer compound while limiting oxidation on the surface of the particles. As a result, there is no precipitation of carbides during sintering, and no formation of large oxides which surround the powder particles and also hinder densification during sintering, by hindering (diffusion barrier) the formation of material necks between particles. This debinding process therefore makes it possible to obtain good densification during sintering and, ultimately, good material health of the sintered part and good mechanical properties, in particular hardness.

In some embodiments, the heat treatment precedes the thermochemical treatment. This enables the polymer compound to be degraded (breaking of carbon chains) before being chemically reacted. The chemical reaction of the thermochemical treatment is therefore more effective. In other embodiments, the heat treatment is carried out after the thermochemical treatment.

In some embodiments, the heat treatment comprises applying an increasing temperature to the green part, for example according to a ramp. A temperature ramp refers to a linear variation in temperature. The temperature controlled in this way (programmed temperature or set temperature) may be the temperature within the enclosure, for example at a reference point, ideally located in the vicinity of the green part, as close as possible to it. A thermocouple or other temperature sensor may be placed at the reference point. For example, a ramp rate may be between 1° C./min and 10° C./min and preferably between 5° C./min and 10° C./min. In other examples, the temperature ramp rate may be greater than or equal to 5° C./min, preferably 6° C./min, more preferably 7° C./min, more preferably 8° C./min, more preferably 9° C./min, more preferably 10° C./min, even more preferably 12° C./min. A rapid increase in temperature not only accelerates the debinding process, which is of industrial interest, but also limits the duration during which the green part is in the presence of oxygen released by the breaking of certain chains of the polymer compound. In this way, oxygen adsorption on the surface of the powder particles is even better controlled. In addition to or instead of the ramp, the heat treatment may include the application of a temperature plateau to the green part. A temperature plateau means that the temperature is kept constant to within a certain tolerance.

In some embodiments, the thermochemical treatment comprises applying a temperature plateau to the green part. In addition to or instead of the temperature plateau, the thermochemical treatment may comprise applying a temperature ramp to the green part.

In some embodiments, the end temperature of the heat treatment is less than or equal to the start temperature of the thermochemical treatment.

In some embodiments, the heat treatment and thermochemical treatment atmospheres may have all or some of the following characteristics, independently of each other:
the non-oxidizing atmosphere is an atmosphere of argon, hydrogenated argon, or even molecular hydrogen or helium, or even a secondary vacuum.
the oxidizing atmosphere is an atmosphere of air, in particular dry air for example synthetic air (80% N₂ and 20% O₂);
the oxidizing atmosphere comprises a mixture of molecular oxygen with an inert gas;
the non-oxidizing atmosphere is renewed during the heat treatment;
the oxidizing atmosphere is renewed during the thermochemical treatment.

A renewed atmosphere refers to an atmosphere that is extracted from the enclosure to be treated and brought closer to its nominal composition (possibly its original composition) before being re-injected into the enclosure. The fact of renewing an atmosphere enables better control of the chemical reactions in the enclosure.

In some embodiments, the predetermined duration is less than or equal to the duration of the heat treatment. Thus, the thermochemical treatment is shorter than the heat treatment. This further limits the undesirable oxidation of the part during debinding.

In some embodiments, the polymer is an organic polymer, for example a thermoplastic or thermoset.

In some embodiments, the predetermined duration is the shortest possible duration for reducing the carbon content of the debinded part, measured by inductively coupled plasma mass spectrometry, to a value less than 1000 ppm, preferably less than 600 ppm, more preferably less than 400 ppm, still more preferably less than 200 ppm. This content may be the additional carbon content of the debinded part relative to the original composition of the powder particles, or the overall carbon content of the debinded part, taking the original composition of the powder particles into account. Inductively coupled plasma mass spectrometry, also known as ICP-MS, is a physical process of chemical analysis which is known per se and which enables virtually all chemical elements to be measured simultaneously. Due to the fact that the predetermined duration is defined in this way, the thermochemical treatment can be relatively rapid and offers a good compromise between the disappearance of the polymer compound and the absence of oxygen adsorbed on the surface of the particles of the debinded part.

Alternatively or in addition, the predetermined duration is defined such that the oxygen content acquired by the debinded part during the debinding process, relative to the original composition of the powder particles, is less than or equal to 2800 ppm, preferably less than 2400 ppm. This acquired oxygen may come from the oxidizing atmosphere but also from the degradation of the polymer compound, more precisely the oxygen released by the breaking of certain chains of the polymer compound, to the exclusion of the oxygen originally contained in the powder particles.

The present disclosure also relates to an indirect additive manufacturing process, comprising obtaining a green part in which powder particles are held together by a polymer compound, the debinding of the green part by the debinding process described above, and the sintering of the debinded part. Through the proposed debinding, this manufacturing process makes it possible to obtain sintered parts with good material health and good mechanical properties, particularly hardness.

In some embodiments, the sintering immediately follows the debinding. This allows the temperature to be raised by the heat or thermochemical treatment to initiate sintering, which is very effective from an industrial point of view. In addition, sintering may take place in the same enclosure as debinding to avoid further handling and contamination of the debinded part.

The present disclosure also relates to a part obtained by the indirect additive manufacturing process described above, in which the mass fraction of oxygen measured by inductively coupled plasma mass spectrometry is less than 0.41%, preferably 0.35%, more preferably 0.1%, more preferably 0.06%, and/or the mass fraction of carbon measured by inductively coupled plasma mass spectrometry is less than 0.11%, preferably 0.08%, and/or the porosity is less than 2%. The part, having undergone sintering, may also be referred to as a “sintered part” as opposed to the part in its states prior to sintering. The oxygen and carbon contents, and/or the porosity are such that such a part has necessarily been debinded by the controlled debinding process as proposed herein.

### BRIEF DESCRIPTION OF THE DRAWINGS

Other features and advantages of the subject matter of the present invention will emerge from the following description of embodiments, provided by way of non-limiting examples, with reference to the accompanying figures.

FIG. 1 schematically illustrates the stages of an indirect additive manufacturing process using binder jetting on a powder bed according to one embodiment.

FIG. 2 is a graph illustrating, not necessarily to scale, the variation in temperature of an enclosure as a function of time for a debinding process according to a first embodiment.

FIG. 3 is a graph illustrating the loss of mass of a green part as a function of time during the debinding process according to the first embodiment and according to a comparative example, as well as the gain in mass measured on the powder, also called the blank, according to the first embodiment.

FIG. 4 is a graph illustrating, not necessarily to scale, the variation in temperature of an enclosure as a function of time for a debinding process according to a second embodiment.

### DETAILED DESCRIPTION

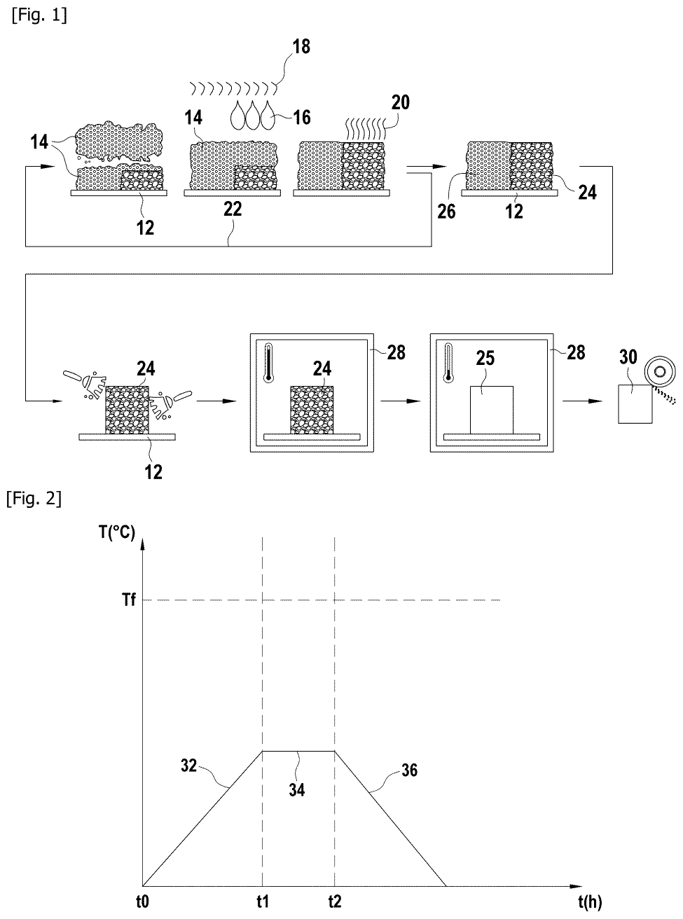

The principle of an indirect additive manufacturing process using binder jetting on a powder bed is illustrated in FIG. 1. The process comprises the formation of successive powder beds 14 on a support 12. Each powder bed 14 is formed on the previous powder bed, except for the first powder bed which may be in direct contact with the support 12.

The powder may be a metallic powder, for example an iron-nickel alloy such as Inconel 718 (registered trademark, the composition of which is detailed in Table 1, with the exception of unavoidable impurities) or more generally a nickel-based superalloy. However, other materials may be considered, such as stainless steel such as SS316L (the composition of which is detailed in Table 2, with the exception of unavoidable impurities). Unless otherwise stated, in this discussion the fractions mentioned are mass fractions.

TABLE 1

| Elements | C | Mn | P | S | Si | Cr | Ni | Mo | O |
|---|---|---|---|---|---|---|---|---|---|
| Min. | 0.02 | — | — | — | — | 17 | 50 | 2.8 | — |
| (mass %) | | | | | | | | | |
| Max. | 0.08 | 0.35 | 0.015 | 0.015 | 0.35 | 21 | 55 | 3.3 | 0.06 |
| (mass %) | | | | | | | | | |

| Elements | B | Ti | Ta | Nb | Cu | Co | Al | Fe |
|---|---|---|---|---|---|---|---|---|
| Min. | — | 0.6 | — | 4.75 | — | — | 0.2 | — |
| (mass %) | | | | | | | | |
| Max. | 0.006 | 1.2 | 0.05 | 5.50 | 0.3 | 1 | 0.8 | Complement |
| (mass %) | | | | | | | | |

TABLE 2

| Elements | C | Mn | P | S | Si | Cr | Ni | Mo |
|---|---|---|---|---|---|---|---|---|
| Min. | — | — | — | — | — | 16 | 9 | 1.5 |
| (mass %) | | | | | | | | |
| Max. | <0.03 | <2 | <0.01 | <0.005 | 1 | 19 | 13 | 3 |
| (mass %) | | | | | | | | |

| Elements | N | O | Fe |
|---|---|---|---|
| Min. | — | — | — |
| (mass %) | | | |
| Max. | <0.003 | <0.002 | Complement |
| (mass %) | | | |

In the above examples, the low oxygen and carbon contents should be noted. In general, the powder material may be selected with the lowest possible oxygen and/or carbon contents, in order to limit oxygen adsorption and carbide formation during the additive manufacturing process. Typically, the initial oxygen content of the powder used can be limited using atomization processes using, for example, a Plasma Rotating Electrode Process (PREP). For example, the oxygen content of the powder particles may be less than 500 ppm, or even less than 150 ppm and preferably less than 50 ppm.

The process also includes selective jetting of binder onto each of the powder beds 14. Thus, after formation of a powder bed, a binder 16 is jetted onto this powder bed 14, before formation of a subsequent powder bed 14. The binder 16 may be jetted by a print head 18, for example in the form of drops. The spraying is said to be selective in that the binder 16 may not be sprayed onto the entire powder bed 14, but only onto a surface that it is desired to print and which corresponds to a section of the part to be manufactured. Such a surface may be defined in a CAD (computer-aided design) file.

The binder 16 may comprise one or more solvents and one or more polymers in solution in all of these solvents. Typically, the polymer may be an organic polymer, for example a thermoplastic or thermoset. For example, the binder may be a mixture of water, ethylene glycol and 2-butoxyethanol (3 solvents) with polyvinylpyrrolidone (1 polymer).

The binder 16 infiltrates the powder bed 14 and may then undergo natural drying 20 (typically at ambient temperature) or forced drying (drying activated by a heat source such as an infrared lamp), during which the binder, and in particular its solvents, partially evaporate. For example, the drying temperature may be between 25° C. and 70° C. It is possible to observe a pause time, for example of order several seconds, between infiltration of the binder 16 and the start of drying.

As shown by the arrow 22, these steps may be repeated, a new powder bed 14 being deposited on the powder bed which has previously received the binder, until the shape of the part to be manufactured, thus constructed layer by layer, is completely printed.

After the part has been printed layer by layer, a cross-linking step is used to finish drying the binder (typically to finish evaporating the solvents) and to polymerize the polymer or polymers. For the sake of brevity, the term polymer compound is used to designate the compound, made up mainly or entirely of one or more cross-linked polymers, which ensures the cohesion of the powder particles. The result is a, generally one-piece, green part 24, the rest of the unprinted powder 26 remaining in granular form. For example, cross-linking may be carried out at a temperature of 200° C. for 12 hours in air. At the end of cross-linking, the green part 24 must have a sufficiently high breaking strength to withstand the following steps. For example, to withstand the handling required for depowdering, it is preferable for the green part 24 to have an equivalent breaking stress in four-point bending (standard test) greater than or equal to 5, 6 or 7 MPa, or even 20, 21 or 22 MPa for worked parts, without which the green part 24 is very likely to deteriorate during depowdering. The expression “equivalent braking stress” is used because the stress calculation formula for this test applies to dense materials, which is not the case for green parts. By way of example, after cross-linking, the polymer compound may comprise between 50 and 60% carbon and between 20 and 30% oxygen, with complementary constituents typically comprising nitrogen and hydrogen.

The green part 24 then undergoes depowdering, which may be carried out in a manner known per se, consisting of removing the unprinted powder remnants 26 from the green part 24. For example, depowdering may be carried out using a compressed air nozzle (typically with a maximum pressure of 2 bar).

The green part 24 may comprise, by volume, between 30% and 70% powder, preferably between 40% and 60%, more preferably around 50%; less than 10% polymer compound, for example between 0.5% and 5%; the remainder of the volume of the green part 24 being formed by pores. As a result of indirect additive manufacturing by binder jetting on a powder bed, the porosity may represent a volume fraction of the green part 24 of at least 20%, preferably at least 30%, preferably at least 40%.

The green part 24 is then debinded and sintered. As illustrated in FIG. 1, debinding may be carried out by placing the green part 24 in an enclosure 28. Debinding may comprise one or more heat treatments and thermochemical treatments of the green part 24 at a temperature higher than the cross-linking temperature of the binder, as will be detailed below.

After debinding, the so-called brown part 25 (or debinded part) may be sintered, in the same enclosure 28 or a different enclosure. For example, sintering may be carried out at a temperature below the solidus, e.g. around 1220° C. for Inconel 718 (registered trademark) which has a solidus of 1260° C., or at a slightly higher temperature but still below the liquidus temperature. The atmosphere in the enclosure 28 may be a secondary vacuum (pressure less than 10-5 mbar) or argon with 5% by volume molecular hydrogen added, or pure molecular hydrogen or a helium atmosphere. Oxygen traps (getters) may be present in the enclosure 28, for example a very oxygen-hungry alloy, in particular a titanium-based alloy such as TA6V.

Sintering can densify the brown part 25, in order to obtain the final part 30. The final part 30 may then be cooled, for example in the enclosure 28 or outside. If necessary, the final part 30 may finally be finished, as shown in the last step of FIG. 1.

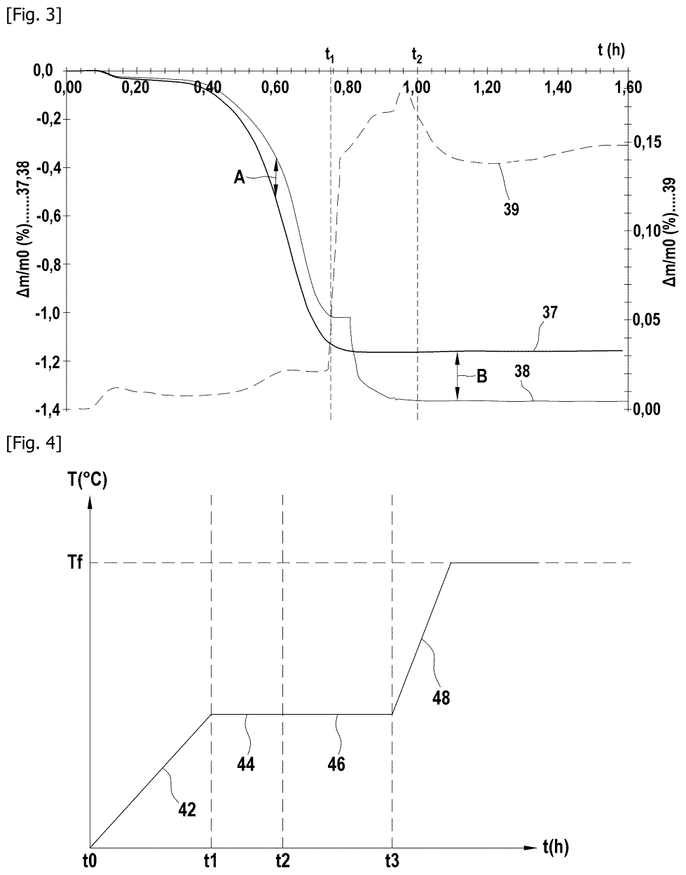

A first embodiment of a debinding process is described with reference to FIGS. 2 and 3. Without loss of generality, the debinding process applied to a green part made of Inconel 718 (registered trademark) is described below, but the principles described below can be transposed to other materials. As described above, the green part 24 is such that the powder particles are held together by the cross-linked polymer compound.

In the first embodiment, the debinding process comprises a heat treatment of the green part 24 under a non-oxidizing atmosphere, in the enclosure 28, at temperatures below the sintering temperature Tf of the powder particles, which is itself below the solidus temperature Ts of the alloy, in this example. The temperature variation applied to the green part may comprise the application of an increasing temperature, for example according to a temperature ramp 32. However, the temperature increase could be non-linear, or interspersed with temperature plateaus. The slope of the ramp is, for example, between 1° C./min and 10° C./min, preferably between 5° C./min and 10° C./min, more preferably around 10° C./min.

In this case, the heat treatment starts at a time to and lasts until a time t1. During this duration, which may range from 30 minutes to 7 hours, preferably between 40 minutes and 1 hour, and yet more preferably about 45 minutes, the atmosphere in the enclosure is non-oxidizing, in particular is oxygen-free. For example, the non-oxidizing atmosphere may be an argon or hydrogenated argon atmosphere or even helium or may be a primary or secondary vacuum. In order to preserve its characteristics, the non-oxidizing atmosphere may be renewed periodically or continuously during the heat treatment. The rate at which the non-oxidizing atmosphere is renewed may be between 1 L/h and 30 L/h, preferably between 2 L/h and 10 L/h, and yet more preferably between 3 L/h and 5 L/h.

The debinding process also comprises, preferably after the heat treatment, a thermochemical treatment of the green part 24 in the same enclosure 28, at temperatures below the sintering temperature Tf of the powder particles. Advantageously, the green part 24 remains in the enclosure 28 between the heat treatment and the thermochemical treatment.

The thermochemical treatment is carried out in an oxidizing atmosphere, i.e. one containing oxygen in a form capable of reacting with the green part 24, in particular with the polymer compound. For example, the oxidizing atmosphere may be an atmosphere of dry air, for example synthetic air, or comprise a mixture of oxygen with an inert gas (typically argon or nitrogen), typically having a mixture of 80% nitrogen and 20% oxygen (volume fractions). However, the oxygen content may be modified, for example to be between 10% and 25% (volume fractions). In order to preserve its characteristics, the oxidizing atmosphere may be renewed periodically or continuously during the heat treatment. The rate at which the oxidizing atmosphere is renewed may be between 1 L/h and 30 L/h, preferably between 2 L/h and 10 L/h, and yet more preferably between 3 L/h and 5 L/h.

The thermochemical treatment is applied to the green part for a duration less than or equal to a predetermined duration, in order to allow the polymer compound to react chemically with the oxygen in the atmosphere, without causing oxidation or excessive adsorption of oxygen on the surface of the powder particles. According to one example, the predetermined duration is less than or equal to the duration of the heat treatment; in other words, the thermochemical treatment is shorter than or of the same duration as the heat treatment.

In FIG. 2, the temperature program applied during the thermochemical treatment is illustrated as a temperature plateau 34 at a temperature above ambient temperature. More specifically, the temperature at which the thermochemical treatment begins may be greater than or equal to the temperature at which the thermal treatment ends; in this case, there is a continuity of temperature between the end of the thermal treatment and the start of the thermochemical treatment. The thermochemical treatment temperature is typically at between 430° C. and 490° C., preferably between 460° C. and 480° C., more preferably around 470° C.

Alternatively, or in addition to the temperature plateau 34, the thermochemical treatment could comprise a temperature ramp, with a gradient greater than, less than or equal to that of the thermal treatment, or any other temperature program enabling the polymer compound to disappear thermochemically.

In FIG. 2, the thermochemical treatment starts at time t1 and lasts until time t2. The duration t2−t1 of the thermochemical treatment may be between 3 minutes and 1 hour, preferably between 4 and 10 minutes, more preferably approximately 5 minutes. As indicated above, the duration t2−t1 of the thermochemical treatment may be less than or equal to the duration t1−t0 of the heat treatment. In total, the proposed debinding process may have a duration t2−t0 of one hour or less.

During the debinding process, for example during the heat treatment and/or the thermochemical treatment, solid carbon may be placed in the enclosure to reduce the oxygen adsorbed on the surface of the metal powder particles. The solid carbon may be provided in contact with the green part 24. The solid carbon may be constituted of more than 90%, or even 95%, of the chemical element carbon. The solid carbon may be provided in powder form (pulverulent solid carbon). In this case, the solid carbon powder particles may have a nanometric size, i.e. their greatest dimension lies between 10 and 100 nanometers. The size of the particles may be measured by Dynamic Light Scattering (DLS), Transmission Electron Microscopy (TEM) or Scanning Electron Microscopy (SEM). This solid carbon, having a large specific surface area, can get, from a certain temperature (in particular at the temperature at which the debinding takes place), the oxygen present in the enclosure during debinding.

After the thermochemical treatment, the green part 24 may be cooled. This is illustrated by a decreasing temperature ramp 36 in FIG. 2, from time t2 at which the thermochemical treatment ends. Although shown here as linear, the temperature drop could be non-linear, or interspersed with temperature plateaus. The green part 24 may be brought back to room temperature before continuing with the indirect additive manufacturing process. At this stage, before the sintering step, a so-called debinded part or brown part 25 is obtained.

FIG. 3 illustrates the relative mass loss Δm/m0 (in %, axis on the left of the figure) with respect to the initial mass of the green part 24 as a function of time during the debinding process according to a comparative example (curve 37) and according to the first embodiment (curve 38). Curves 37, 38 were obtained for similar but distinct green parts.

As can be seen from FIG. 3, the mass of the green part 24 decreases during the heat treatment, between t0 and t1, which corresponds to the pyrolysis of the polymer compound, both for the first embodiment (curve 38) and for the comparative example (curve 37). As the end of the heat treatment approaches, the mass loss may slow down. A difference in mass loss, denoted A in FIG. 3, may appear between the parts because these parts may comprise slightly different quantities of polymer compound due to the layering step (compactness gradient of the powder bed) and the printing step, which generate heterogeneous infiltration of the binder within the powder bed, resulting in different amounts of polymer compound to be degraded during debinding.

At time t1, the heat treatment of the comparative example (curve 37) continues under the same atmosphere, until the end of the debinding process, and does not enable the mass of the green part 24 to be reduced any further, while the heat treatment of the first embodiment (curve 38) gives way to the thermochemical treatment which immediately follows it and leads to a clear further mass loss. Around time t1 (in FIG. 3: immediately after t1), a small delay may be observed due to the purging of the non-oxidizing atmosphere in order to replace it with the oxidizing atmosphere. This second phase of mass loss, which also contributes to the final difference B compared with the comparative example (curve 37), is linked to the chemical reaction of the polymer compound during the thermochemical treatment, the products of which are mainly released into the atmosphere. Mass loss may then slow down when most of the polymer compound has been removed from the green part 24. At this stage, the carbon content of the green part 24, measured by inductively coupled plasma mass spectrometry, is preferably less than 1000 ppm, preferably less than 600 ppm, even more preferably less than 400 ppm, yet more preferably less than 200 ppm.

In reality, the green part 24, during debinding, undergoes a slight increase in mass due to the oxygen captured by the green part 24 from the oxidising atmosphere. The mass gain measured on the powder alone in the absence of the polymer compound, sometimes called “blank” and illustrated by curve 39 in FIG. 3 (right axis), was quantified separately and subtracted from curve 38 in FIG. 3 In this way, curve 39 in FIG. 3 only represents the mass gain linked to the surrounding atmosphere and not to the oxygen coming from the degradation of the polymer compound because the “blank” is measured on powder in the absence of polymer compound. As can be seen from curve 39, mass gain in the absence of polymer is less than 200 ppm during the heat treatment, and is therefore very limited. This is assessed by thermogravimetric analysis and additional ICP measurements of oxygen and, if necessary, carbon.

Ideally, the thermochemical treatment is interrupted before oxidation and oxygen adsorption become excessive, for example by replacing the oxidizing atmosphere with a non-oxidizing atmosphere such as a vacuum at the desired level. The predetermined duration, which sets an upper limit on the duration of the thermochemical treatment, may be less than or equal to the duration required to obtain the aforementioned carbon contents. Through these provisions, the gain in oxygen mass, compared with the original composition of the powder particles, can be limited to a value less than or equal to 2800 ppm, preferably 2400 ppm. Furthermore, insofar as the oxygen present in the polymer compound contributes significantly to the contamination of the powder particles during debinding, it is advantageous to minimize the oxygen content of the polymer compound, for example by using a binder with a monomer depleted of oxygen atoms. More generally, the gain in oxygen mass may be further reduced by selecting a binder whose polymer compound is unlikely to release oxygen during debinding, and/or by limiting the binder saturation (quantity of binder, depending in particular on the number of passes of the print head per powder bed) of the part during the printing stage.

The sintered part 30 obtained on the basis of the thus debinded green part has good material health and good mechanical properties: on the one hand, the small amount of oxygen picked up by the powder after debinding results in good density and efficient sintering through the rapid formation of material necks. On the other hand, the very small amount of carbon-containing residues prevents the formation of niobium-rich or titanium-rich carbides during sintering, which typically allows the niobium to participate in the precipitation of the hardening phase γ″-Ni₃Nb which contributes significantly to the hardness of the material.

The sintered part 30 thus obtained is such that the mass fraction of oxygen measured by inductively coupled plasma mass spectrometry is less than 0.41%, preferably 0.35%, more preferably 0.1%, most preferably 0.06%. Furthermore, the mass fraction of carbon measured by inductively coupled plasma mass spectrometry is less than 0.11%, preferably 0.08%. Furthermore, the porosity is less than 2% (porosity always being expressed as a volume fraction, by definition).

For example, an Inconel 718 part manufactured by the indirect additive manufacturing process described above has a hardness of between 34 and 44 HRC (Rockwell C hardness) and an average grain size corresponding to ASTM No5 or finer (in accordance with the requirements of AMS 5917:2017), which is made possible by complete debinding avoiding the precipitation of carbides or oxides at the grain boundaries.

FIG. 4 shows a debinding process according to a second embodiment. In this figure, the elements corresponding or identical to those of the first embodiment will receive the same reference sign, except for the tens digit, and will not be described again.

According to the second embodiment, the debinding process comprises a heat treatment comprising a temperature ramp 42, from a time to to a time t1, followed immediately by a thermochemical treatment comprising a temperature plateau 44, from time t1 to a time t2. The second embodiment differs from the first in that sintering of the part immediately follows debinding, optionally in the same enclosure 28. To this end, instead of cooling the debinding part according to ramp 36, a secondary vacuum is created in enclosure 28 from time t2 to time t3. During this duration, the part is held on a temperature plateau 46, for example at the same temperature as the temperature plateau 44 of the thermochemical treatment, and in any case held at temperatures below the sintering temperature Tf. Once the desired vacuum level has been reached, referenced by the time t3, the temperature in the enclosure 28 may be increased so as to reach the sintering temperature Tf without ever exceeding the liquidus temperature of the alloy (in the case of super-solidus sintering), or even the solidus temperature Ts of the alloy, and thus to sinter the powder particles. Sintering may then be carried out by a person skilled in the art in accordance with his knowledge.

Although the present description refers to specific exemplary embodiments, modifications can be applied to these examples without going beyond the general scope of the invention. In addition, the individual features of different embodiments illustrated or mentioned can be combined in additional embodiments. Consequently, the description and the drawings should be considered as illustrating rather than limiting.

What is claimed is:

1. A process for debinding a green part in which powder particles are held together by a polymer compound, the process comprising a heat treatment of the green part under a non-oxidizing atmosphere, and a thermochemical treatment of the green part under an oxidizing atmosphere for a duration less than or equal to a predetermined duration, the heat treatment and the thermochemical treatment being carried out in a same enclosure and at temperatures less than a sintering temperature of the powder particles, wherein the heat treatment comprises applying an increasing temperature to the green part, a rate of temperature increase being greater than 5° C./min.

2. The debinding process according to claim 1, wherein the heat treatment precedes the thermochemical treatment.

3. The debinding process according to claim 1, wherein the applying an increasing temperature to the green part is carried out according to a ramp.

4. The debinding process according to claim 1, wherein the thermochemical treatment comprises applying a temperature plateau to the green part.

5. The debinding process according to claim 1, wherein an end temperature of the heat treatment is less than or equal to a start temperature of the thermochemical treatment.

6. The debinding process according to claim 1, wherein the non-oxidizing atmosphere is an atmosphere of argon, hydrogenated argon, molecular hydrogen or helium, or a secondary vacuum.

7. The debinding process according to claim 1, wherein the oxidizing atmosphere is an atmosphere of air, optionally of synthetic air.

8. The debinding process according to claim 1, wherein the oxidizing atmosphere comprises a mixture of oxygen with an inert gas.

9. The debinding process according to claim 1, wherein the non-oxidizing atmosphere is renewed during the heat treatment.

10. The debinding process according to claim 1, wherein the oxidizing atmosphere is renewed during the thermochemical treatment.

11. The debinding process according to claim 1, wherein the predetermined duration is less than or equal to the duration of the heat treatment.

12. The debinding process according to claim 1, wherein the cumulative duration of the heat treatment and the thermochemical treatment is less than or equal to one hour.

13. The debinding process according to claim 1, wherein the polymer is an organic polymer, optionally a thermoplastic or thermoset.

14. The debinding process according to claim 1, wherein the predetermined duration is the shortest possible duration for reducing the carbon content of the debinded part, measured by inductively coupled plasma mass spectrometry, to a value less than 1000 ppm, optionally less than 600 ppm, optionally less than 400 ppm, optionally less than 200 ppm.

15. The debinding process according to claim 1, wherein the predetermined duration is defined such that the oxygen content acquired by the debinded part during the debinding process, relative to the original composition of the powder particles, is less than 2800 ppm, optionally less than 2400 ppm, said oxygen content resulting from the degradation of the polymer compound and the oxidizing atmosphere.

16. The debinding process according to claim 1, wherein solid carbon is placed in the enclosure for at least one of the heat treatment and the thermochemical treatment.

17. The debinding process according to claim 16, wherein the solid carbon is pulverulent carbon placed in contact with the green part.

18. An indirect additive manufacturing process, comprising:
obtaining a green part in which powder particles are held together by a polymer compound,
debinding the green part, and
sintering the debinded part, wherein optionally the sintering immediately follows the debinding, optionally in the same enclosure.

19. A part obtained by an indirect additive manufacturing process in which the part has at least one of the following characteristics: a mass fraction of oxygen measured by inductively coupled plasma mass spectrometry is less than 0.41%, optionally 0.35%, optionally 0.1%, optionally 0.06%; the mass fraction of carbon measured by inductively coupled plasma mass spectrometry is less than 0.11%, optionally 0.08%; the porosity is less than 2%.
